(19) United States
(12) Patent Application Publication
(10) Pub. No.: US 2003/0136199 A1
(43) Pub. Date: Jul. 24, 2003

(54) Measurement apparatus and technique for properties of board products

(76) Inventors: Murray Singleton, Victoria (AU); Mark Kortschot, Ontario (CA)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/181,521

(22) PCT Filed: Jan. 19, 2001
(86) PCT No.: PCT/AU01/00050

(30) Foreign Application Priority Data
Jan. 19, 2000 (AU) PQ 5151

(51) Int. Cl. G01N 3/24; D21F 11/00; D21F 7/06

(52) U.S. Cl. 73/846; 162/198; 162/263; 493/37

(57) ABSTRACT

Method and apparatus for measuring, monitoring and/or providing an indication of material “damage” in board products, particularly Machine Direction (MD) Shear. In this regard, the present document discloses applying a predetermined force to a board product such that the board product is not deflected beyond its elastic region. The apparatus used for applying the force is preferably of a size or structure suitable for physically limiting the amount of deflection of the board product. By maintaining the board product within its elastic region as such, the occurrence of permanent damage to the board product is reduced. Hence, the disclosed method and apparatus are able to provide a non-destructive indication of MD Shear on the paperboard product being tested, and are thus suitable for use in on-line testing/monitoring of paperboard production.

### TECHNICAL FIELD

This invention relates to improvements in methods and apparatus for measuring properties of board products, including structural and strength properties such as “damage” with its relationship with shear stiffness, particularly Machine Direction (MD) Shear. The invention also has application to an “in production” measurement of properties of paperboard.

### BACKGROUND ART

In the manufacture of board products, especially paperboard products, such as corrugated paperboard, it is desirable to measure various parameters in order to define the structural properties of the paperboard, particularly for quality control purposes. One desirable property to measure is material “damage” which provides an indication of medium degradation that has occurred to the paperboard, particularly during manufacture. For example, during the manufacture of corrugated paperboard products, damage may occur to the board during various stages of the manufacturing process, particularly during the step of adhering the fluted medium(s) to the liner boards and the stage of printing matter onto the surface or surfaces of the paperboard. These stages may result in “damage” to the fluted mediums, in that the fluted medium may be compressed, sheared or forced sideways in relation to their bonding with one or more of the liners. This damage is not usually visually apparent, so a testing procedure is required to assess the extent of shear that has occurred.

To date, since it is difficult to accurately and conveniently assess the degree of damage to paperboard products during manufacture, many corrugated medium products, such as boxes, are produced using heavier grade boards than would be necessary if the degree of damage to the corrugated medium was monitored and minimised.

As indicated above, a property that provides an indication of the paperboard strength in terms of the “damage” to the paperboard, is shear stiffness, particularly machine direction (MD) shear. One method for measuring this shear stiffness is by a twisting test. In this regard, a fundamental relationship has been established between the shear stiffness of the core of a board and its stiffness to twisting. Although this approach achieves relatively accurate results, one problem is that it requires onerous sample preparation including cutting boxes or blanks. This sample preparation is particularly onerous, as the twisting test apparatus is sensitive to the width of the sample used, as a small error in the width will greatly affect the result achieved with the twisting test apparatus. Therefore a special cutter is also required in order to accurately control the width of the sample and also minimise damage to the sample proximate the cut. In addition, the apparatus to effect the twisting movement is relatively complex and of considerable expense. Further, the method is not suitable for use “in production”, such as in an on-line testing method, or on finished paperboard products, as the test itself causes “damage” to the paperboard. This testing method is therefore categorised as a “destructive” test, and as such, repeated testing of the same sample does not provide reliable results.

It is therefore an object of the present invention to provide a more efficient and/or cost effective means of measuring material “damage” in board products and, in general, to overcome or alleviate at least one of the problems of the prior art.

It would be desirable to obtain a measurement method and apparatus adapted for use in relation to finished or near-finished board products, to indicate the level of “damage” of the product, but that does not introduce permanent damage.

It would also be desirable to obtain a measurement method and apparatus adapted for use on-line which is able to continuously monitor and indicate the level of damage occurring to a corrugating medium during manufacture, and which avoids introducing permanent damage to the paperboard being measured. In this regard, real-time feedback is also desirable in that it would allow machine operators to make real-time and informed decisions in order to minimise product variability, as well as maximise product strength and quality.

### SUMMARY OF THE INVENTION

According to a first aspect, the present invention provides an apparatus for providing an indication of shear stiffness of a board product, the apparatus including a plurality of measurement surfaces adapted to abut a board sample, with at least two of the surfaces spaced apart to form a measurement region, a force-applying means for applying a force to the board sample adjacent the measurement region, the means sized so that the force applied does not deflect the board sample beyond a predetermined elastic region.

Preferably the surface spacing is between 3 and 10 flutes of the board product.

In this aspect, the present invention provides a means by which board products, such as corrugated paperboard products, are able to be tested whilst minimising damage to the products, and without the need for cutting samples. This aspect therefore avoids the time required to prepare samples. In addition, the present invention may be applied in situ, providing qualitative feedback.

According to another aspect, the present invention provides a board product manufacturing apparatus including a means for measuring strength characteristics of a paperboard product, the measuring means including a plurality of surfaces adapted to abut a moving web of paperboard, with at least two of the surfaces spaced apart to form a region adapted to receive deflected paperboard; a load means adapted to apply a selected deflection force to the paperboard product adjacent the region between the two surfaces; a control means adapted to maintain the deflection of the paperboard within its elastic deflection region; at least one sensor means for obtaining measurement data relating to the force applied to the paperboard product as well as data relating to the degree of displacement of the paperboard product; and a means for calculating a strength characteristic of the paperboard product using the force data mapped against the displacement data.

This aspect of the invention in applying a predetermined force, being an amount that ensures that the board product is not deflected beyond its elastic region, has been found to substantially reduce permanent damage occurring to the board product.

In regard to this further aspect, the present invention is able to provide an indication of the performance of paper manufacturing apparatus, such as corrugating apparatus, in an ‘on-line’ environment, in a manner that provides a non-destructive indication of the paperboard product being produced. The ability of the present invention to selectively determine/control the degree of deflection of the paperboard has made it particularly applicable to on-line measurement.

According to a further aspect, the present invention provides a device for monitoring paperboard being manufactured by a paperboard manufacturing apparatus, the device including:

means for applying an MD shear testing method directly to the paperboard being manufactured and;

means for maintaining the application of the MD shear test within an elastic deflection region.

The present invention also provides a method of testing board products as an aid in processing paperboard products, including the steps of:

applying a measured deflection force to a paperboard product, the force being measured so that the paperboard product is deflected within an elastic deflection region;

measuring the displacement of the paperboard product resulting from the applied force;

using the measured displacement to obtain an indication of a property of the board product.

Preferably, the property of the board product for which an indication is obtained is the shear stiffness of the board product.

Accordingly, in another aspect, the present invention provides, in an in-line process for manufacturing paperboard, a method of determining a strength characteristic of the paperboard product, the method including the steps of:

applying a deflection force to a moving web of the paperboard product;

selectively adjusting the deflection force in order to maintain the deflection of the paperboard product with an elastic deflection region; and

measuring the applied force and corresponding displacement of the paperboard product.

In a preferred embodiment of the invention, in an in-line process for manufacturing paperboard, the above method includes the further step of applying the applied force data against the displacement data.

In yet a further aspect, the present invention provides a method of monitoring paperboard being manufactured by a paperboard manufacturing apparatus, the method including the step of:

testing the shear strength of manufactured paperboard by application of an MD shear testing method directly to the paperboard wherein the MD shear testing method maintains deflection of the paperboard within an elastic deflection region.

Preferably the board product is corrugated paperboard, and the test is conducted in a region of the paperboard being 3 to 10 flutes in length. The invention also provides a device for performing this method.

In essence, the invention stems from realising that by providing the ability to control MD shear measurement such that the force applied during testing does not exceed the elastic deflection region of the paperboard being tested, a non-destructive testing means and method may be provided, including an ‘on-line’ testing/monitoring of paperboard production. In one form, the invention is implemented by way of knowing the characteristics (such as deflection characteristics) that should be exhibited by the particular paperboard being manufactured at any one time, and using an MD shear testing apparatus to test/monitor the quality of the paperboard by applying force to cause deflection in accordance with the known characteristics. In other words, the invention can be seen as a means of confirming that paperboard manufactured (or in the process of being manufactured) meets a required standard, as exhibited in an MD shear test, such as a deflection test.

Particularly with the on-line embodiment of the invention, additional apparatus can be used to feedback production control information to adjust the production parameters and/or deflection applied by the MD shear testing apparatus.

It is also to be appreciated that preferably the MD shear testing apparatus is a three point compression apparatus, however, it is not the only type of device that may be used.

### BRIEF DESCRIPTION OF THE DRAWINGS

An illustrative embodiment of the invention will now be described with reference to the accompanying drawings, in which:

FIG. 1 illustrates a first embodiment of a static MD shear testing apparatus. FIG. 2 illustrates a perspective view of the plunger of FIG. 1 between two surfaces.

FIG. 3 a graph of the compression force against the displacement from a test using the apparatus of FIG. 1.

FIG. 4 is a graph showing the results of multiple test cycles on a paperboard sample within the elastic region.

FIG. 5 is a graph showing the results of multiple test cycles on a paperboard sample beyond the elastic region.

FIG. 6 illustrates a ridged platen according to one embodiment of the invention.

FIG. 7 shows a graph of the expected force displacement of the ridged platen of FIG. 6.

FIG. 8 illustrates a three point compression apparatus according to a particular embodiment of the invention.

FIG. 9 illustrates a wheel with a ridge according to another embodiment of the invention.

FIG. 10 is a graph of compression modulus data calculated from the graph of FIG. 3, mapped against MD Shear data obtained via a twisting test using an equivalent paperboard sample to that used to obtain the FIG. 3 results.

FIG. 11 shows a graph of simulated MD shear against known MD shear values for various samples of different grammage.

FIG. 12 shows a graph of a liner grammage scale factor that is able to be applied to compression modulus data obtained from a three point measurement apparatus in order to scale the data according to the particular grammage of the paperboard liner being measured.

FIG. 13 illustrates a graph of on-line MD shear measurement data against corrugator speed.

FIG. 14 illustrates a logarithmic on-line relationship between corrugator speed and on-line MD shear measurement data.

FIG. 15 illustrates a graph of true MD shear data against on-line MD shear measurement data corrected with the logarithmic relationship of FIG. 11.

FIG. 16 illustrates a graph of MD shear measurement values for various board types against the air pressure of a pneumatically operated plunger.

### DETAILED DESCRIPTION OF A PREFERRED EMBODIMENT

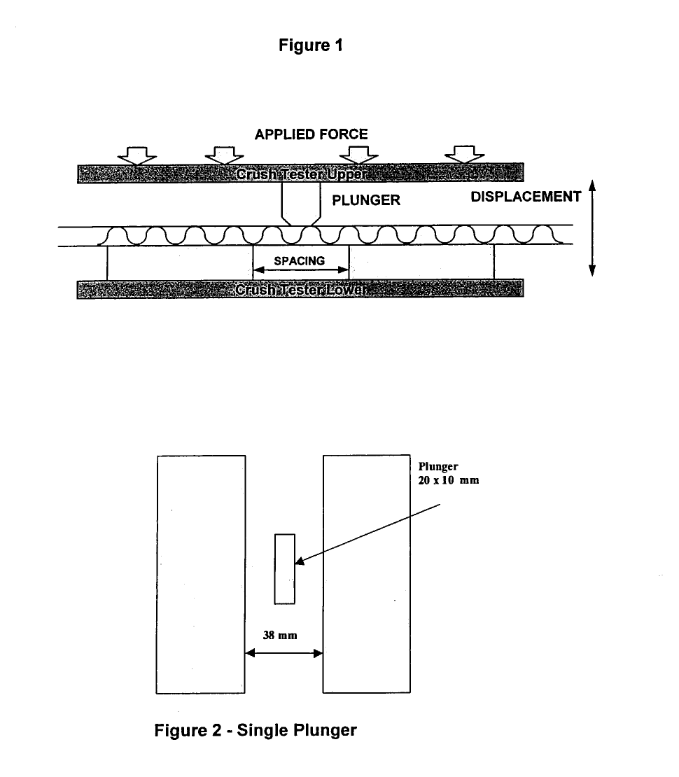

A first embodiment of a static MD shear three-point compression test apparatus is illustrated in FIG. 1. In this embodiment of the invention, a first surface (labelled “crush test upper”) is provided with a projecting element, such as the plunger. Adjacent this first surface, are two spaced apart second surfaces, with a region formed therebetween (labelled as “spacing”). The distance between the two platforms is important, as if it is too wide, the test will approximate a bending test and the paperboard will not necessarily exhibit shear. Preferably the distance between the two surfaces is equivalent to between 3 and 10 flutes, with a distance equivalent to 5 flutes being most preferable.

This construction of this apparatus is such that it prevents deflection of a board product being tested beyond the elastic region of the product. “The elastic region”, is the region where force can be applied to the board product non-destructively. In other words, if the board product is deflected beyond its elastic region, it will sustain a degree of permanent damage and a corresponding strength reduction.

It is also to be appreciated that the surface area of the first and second surfaces also play a part in the effectiveness of the present test, as they both serve to constrain the deflection of the paperboard, thus assisting in constraining the deflection to within the elastic region

Further, it is preferable that the plunger is actuated via a pneumatic ram. In this embodiment of the invention, the air pressure, together with the surface area of the first and second surfaces, affects the maximum pressure applied to the sample. As too much pressure will increase the force applied to the board, and therefore damage the board, the air pressure of the pneumatic ram should be regulated. In this regard, FIG. 16 illustrates the MD shear results for different corrugated board grades in the same testing apparatus. This Figure shows a decrease in MD shear as the pressure applied increases, which indicates that damage is occurring to the board. Air pressure levels of above 1.5 Bar (which is approximately 100 kPa) all show a loss in MD shear, so that the pressure applied to the board product should be maintained below this level in order to minimise the risk of damage to the board product.

FIG. 2 illustrates a perspective view of the plunger of FIG. 1 between the two surfaces. In this embodiment the plunger dimensions are 20×10 mm and the spacing between the two surfaces is 38 mm. The 38 mm spacing corresponds to approximately 5 flutes for “C” flute. With this embodiment of the invention, and testing C-flutes, it has been found that the force applied to the board results in MD shearing, but does not deflect the board beyond its elastic region.

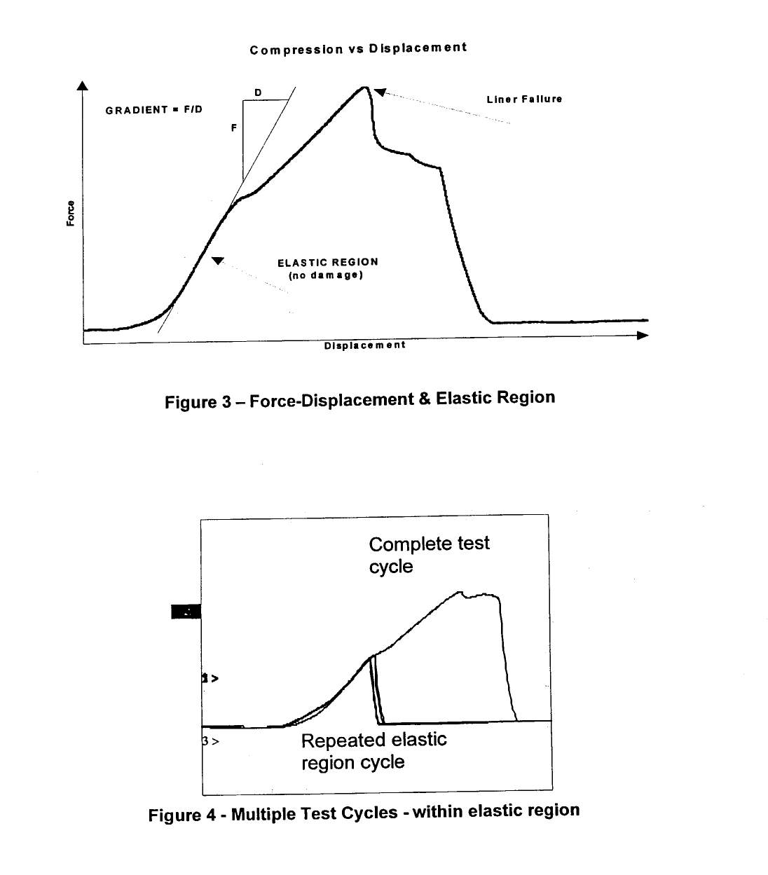

To illustrate the elastic region, FIG. 3 shows a graph of the compression force applied by a three point compression apparatus against the displacement resulting from the applied pressure. To obtain these results, the reported units were in mV, with the crush tester speed being 12.5 mm/min and the mV output proportional to the force (approximately 1 mV/N). The board grade used with the experiment were C-flute-210-210-140, and it was constant throughout to minimise the effect of extra variables and at ISO conditions. The jig construction used in this test was a gap spacing of 5 flutes (approximately 38 mm for C flute) and plunger dimensions of 1 flute width (approximately 8 mm for C flute), and 20 mm length.

These test results in FIG. 3 clearly show an “elastic region” 10 where the paperboard could be elastically displaced without any permanent damage to the board. The peak of the graph shows the point at which the board product failed. In this test, the upper bound of the elastic region was found to be approximately 1 mm.

To illustrate the need to operate the measurement apparatus only in the elastic region, FIG. 4 provides test results of multiple test cycles on a paperboard sample within the elastic region. From this figure, it is apparent that no appreciable permanent damage is occurring to the paperboard sample, as consistent results are obtained.

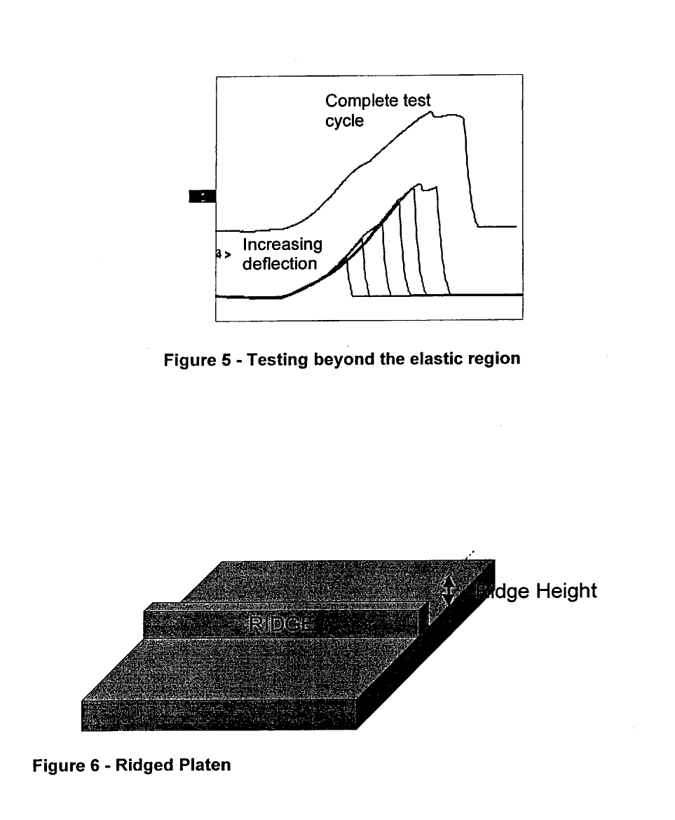

FIG. 5, on the other hand, provides test results of multiple test cycles on a paperboard sample beyond the elastic region. This figure indicates that some permanent change in the sample's characteristics occur once the elastic region is exceeded, as there is increasing deflection in the sample, rather than the relatively uniform result of FIG. 4. This therefore confirms that if the deflection is limited to within the elastic region, a non-destructive test will be performed.

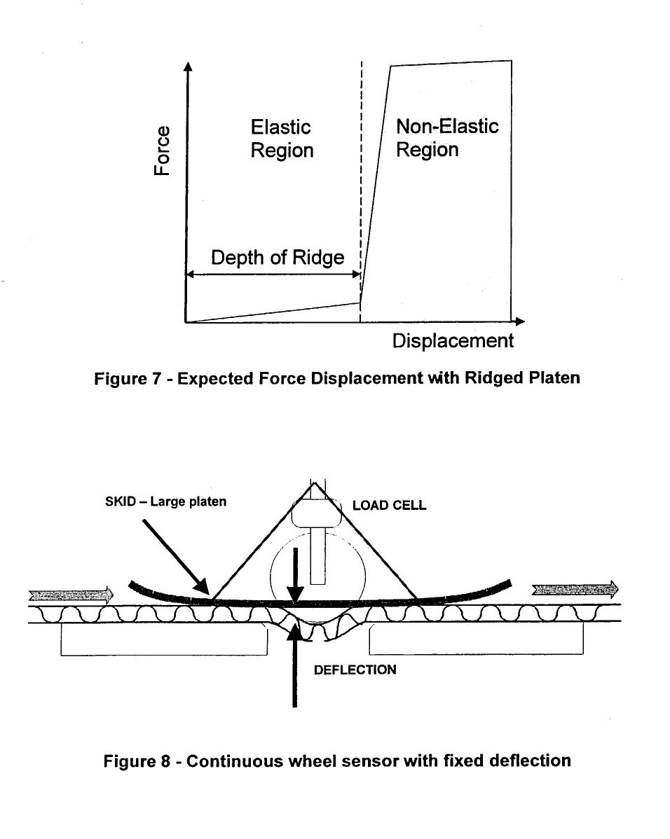

Shown in FIG. 6 is a flat platen with a protruding ridge. This platen is another embodiment of the first surface and plunger as shown in FIG. 1. The protruding ridge is sized to such an extent that even at the maximum degree of deflection using this platen, the paperboard is not displaced beyond the elastic region. In other words, in operation the action of the protruding ridge applying force/pressure to a board product serves to deflect the sample a known amount, wherein the known amount does not exceed the elastic region. A graph showing the expected force displacement using the ridged platen of FIG. 6 is illustrated in FIG. 7.

A particular advantage of this embodiment of the invention is that by virtue of the dimensions of the apparatus being carefully configured, the apparatus is in effect self-limiting, so that the applied force generally avoids the force/area (pressure) levels that would introduce damage to the board.

A first embodiment of an on-line apparatus adapted to displace a board product to a degree not exceeding the elastic region is disclosed in FIG. 8. In this embodiment, the circumference of the wheel is of constant proportion and is attached to a load cell. It has been found that the ability of the load cell/wheel assembly to deflect is an important feature of this embodiment of the inventive apparatus, as it enables the degree of deflection applied to the board to be controlled, thereby ensuring that no permanent damage is introduced to the board.

A further feature of the assembly in FIG. 8 is the ability of the mechanism to automatically compensate for differences in board thickness, in that the system uses a surface of the board as a passive zero reference. In other words, if the thickness of the corrugated board increases or decreases then the load cell/wheel assembly is able to move in sympathy. This may be achieved using a ski or skid type footprint that rides on the corrugated paperboard surface, with no mechanical coupling to the underneath structure. The actual measuring wheel protrudes through the base of the skid deflecting the board. Such a wheel assembly would be particularly suited for use in a continuous web process such as on a corrugating machine. As an alternative to the skid, a wheel or wheels may be utilised.

It is to be appreciated that it is preferable the diameter of the measuring wheel is not too small in size as this may cause the pressure applied to the board to be localised, so that permanent damage is more likely to occur to the board. Therefore, a reasonably wide mechanism is desirable. With the C-flute paperboard as described above, a width of 25 mm has been found to be workable.

While the embodiment of FIG. 8 does incorporate control apparatus, it has the additional advantage of being adaptable in terms of the amount of force to be applied. Therefore, its measurement is independent of the thickness of the paperboard, so that it may be used for paperboard of varying qualities by measuring the degree of pressure applied to the load cell.

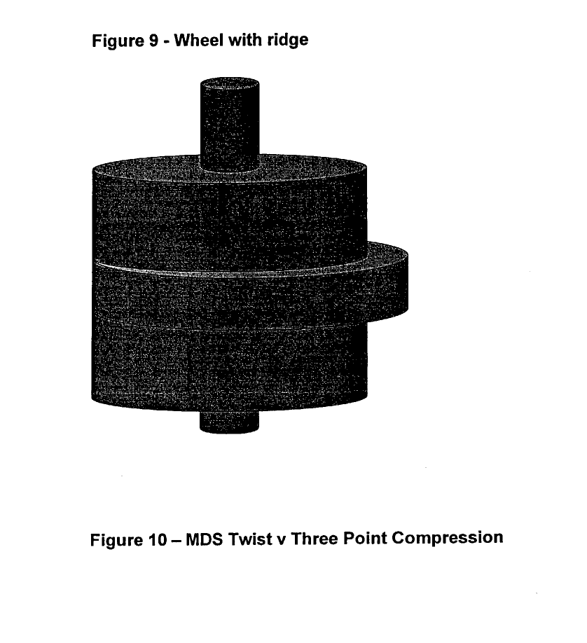

In a further alternative embodiment of the on-line measurement apparatus of the present invention, a rotating wheel with a ridge, which may be used to replace the constant circumference wheel of FIG. 8. As shown in FIG. 9, the wheel may have the ridge/groove in only half of the surface around the circumference of the wheel. A particular advantage of this embodiment of the invention, is that the measurement may be effected via a difference measurement without the need for a force zero reference.

It is to be appreciated that kinematic inversions of these various apparatus configurations are also possible without departing from the spirit of the invention. For example, the wheel may be located beneath the board being tested, and/or the load assembly may be connected to the platform assembly, so that it is the platform assembly that is adapted to move. The degree of displacement may then be measured, as well as the degree of force applied.

These force/displacement measurements may then be used to obtain data results indicative of MD shear. In this regard, by mapping the force applied versus the degree of displacement, such as shown in FIG. 3, and then calculating the gradient of the curve in the elastic region, compression modulus data can be obtained. This compression data has a linear correlation with MD shear. This correlation between the compression modulus data and MD shear is indicated in FIG. 10. FIG. 10 is a graph of the compression data obtained from FIG. 3, against MD shear data calculated using the twisting test with an equivalent paperboard sample. This graph of FIG. 10 verifies that there is a good correlation between the test results of the three point measurement apparatus and MD shear. It is to be appreciated that this data was obtained using C-flute board, and the apparatus configuration as indicated above.

One discrepancy encountered through use of the on-line measurement apparatus of the present invention, was in regard to different relationships between MD shear and three-point compression being obtained with differing board grades.

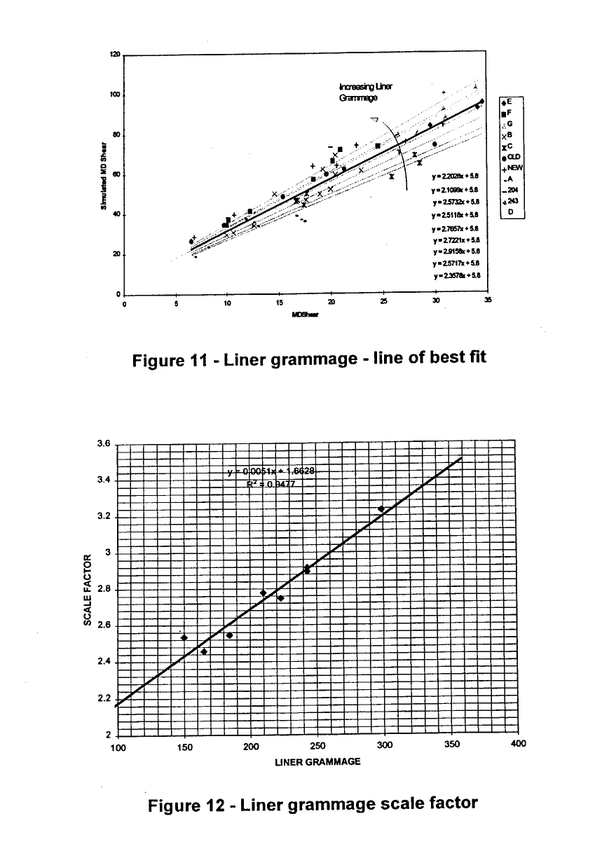

To overcome this problem, the discrepancy was found to be related to the grammage of the corrugated board. In this regard, by separating grade details, and getting a line of best fit (see FIG. 11), a relationship between liner grammage and the slope of each grade “line of best fit” was obtained. This relationship is shown in FIG. 12, and is able to be used to obtain MD shear results according to the board grade used.

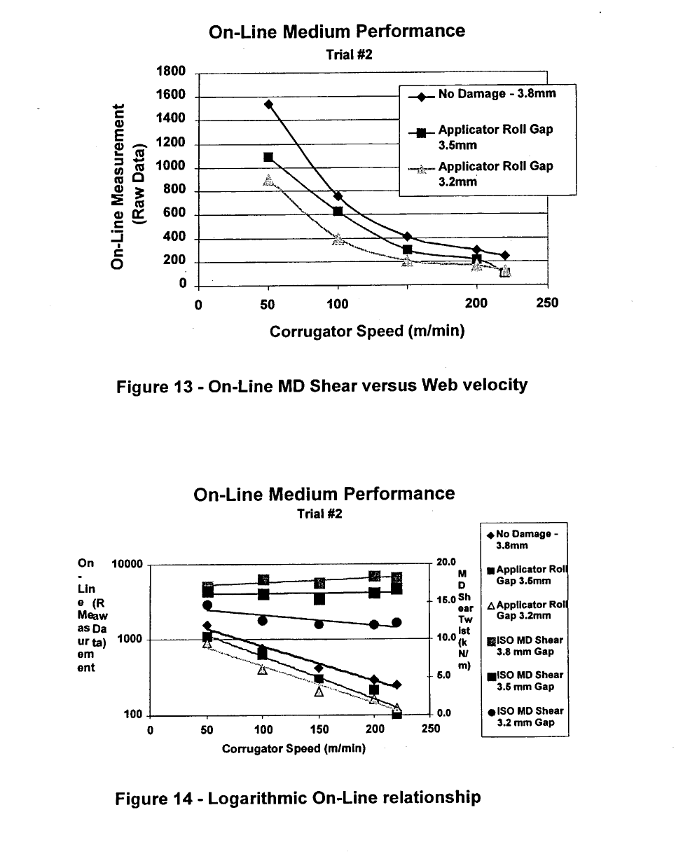

A further problem that arose as a result of undertaking on-line measurements was that the results demonstrated a strong dependency on the velocity of the web, as shown in FIG. 13. Initially this problem was considered to be due to the measurement head “lifting” as the speed increased, resulting in a reduction in output signal level.

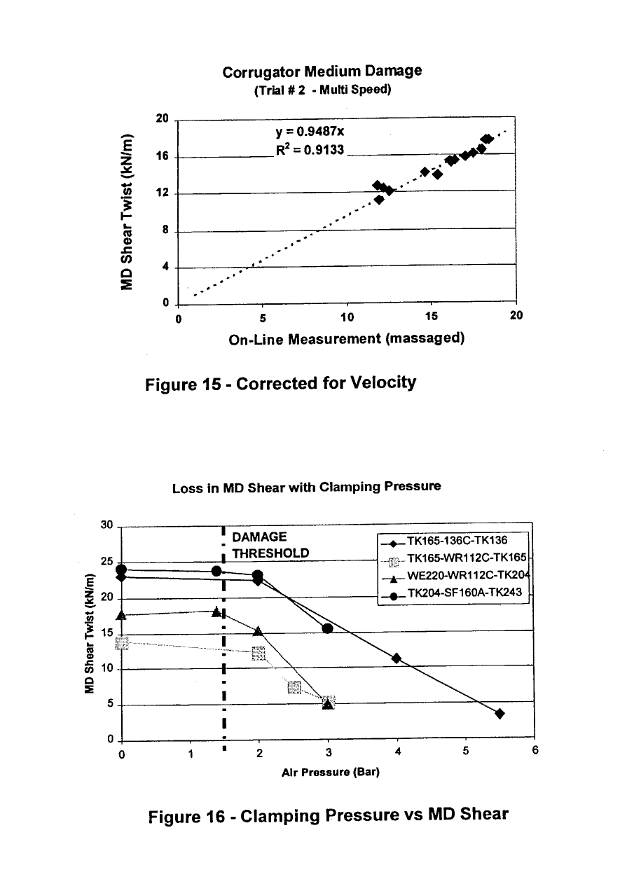

However, it was found that the results were not incorrect, and that there was not reductions in MD shear with increasing speed. Instead, it was found that there was a true dependency of the MD shear measurement on speed, according to a logarithmic relationship. This relationship is shown in FIGS. 14 and 15.

Therefore in order to obtain true measurement data, the data is corrected according to this logarithmic relationship, where the factor of correction will depend upon the speed of the web being measured.

Variations and additions are possible within the general inventive concept as will be apparent to those skilled in the art.

For example, it is to be appreciated that it is not essential to the invention that the force applying means is applied parallel with the machine direction of the board product. It is possible to offset the force-applying means to a reasonable degree without adversely affecting the MD shear measurements to any great extent.

In addition, the force may be applied on or off the flute tips of a corrugated board product without any significant variation in measurement occurring.

The claims defining the invention are as follows:

1. An apparatus for providing an indication of shear stiffness of a board product, the apparatus including:
a plurality of measurement surfaces adapted to abut a board sample, with at least two of the surfaces spaced apart to form a measurement region;
a force-applying means for applying a force to the board sample adjacent the measurement region, the means sized so that the force applied does not deflect the board sample beyond a predetermined elastic region.

2. The apparatus of claim 1 wherein the means for applying a force is a rectangular platen.

3. The apparatus of claim 1 wherein the board product is corrugated paperboard, and the at least two measurement surfaces are spaced at a distance equivalent to a spacing of between 3 and 10 flutes of the corrugated board.

4. A method of testing board products as an aid in processing paperboard products, including the steps of:
applying a measured deflection force to a paperboard product, the force being measured so that the paperboard product is deflected within an elastic deflection region;
measuring the displacement of the paperboard product resulting from the applied force;
using the measured displacement to obtain an indication of a property of the board product.

5. The method of claim 4 wherein the property is shear stiffness.

6. A paperboard manufacturing apparatus including a means for measuring strength characteristics of a paperboard product, the measuring means including:
a plurality of surfaces adapted to abut a moving web of paperboard, with at least two of the surfaces spaced apart to form a region adapted to receive deflected paperboard;
a load means adapted to apply a selected deflection force to the paperboard product adjacent the region between the two surfaces;
a control means adapted to maintain the deflection of the paperboard within its elastic deflection region;
at least one sensor means for obtaining measurement data relating to the force applied to the paperboard product as well as data relating to the degree of displacement of the paperboard product; and
a means for calculating a strength characteristic of the paperboard product using the force data mapped against the displacement data.

7. The apparatus of claim 6 wherein the load means is one of:
a constant circumference rotatable wheel with a load cell adapted to selectively adjust the deflection force applied to the paperboard product in order to maintain the deflection of the paperboard product within its, elastic deflection region;
a rotatable wheel with a ridge about at least a portion of the circumference of wheel, such that the ridge is shaped so as to maintain the deflection of the paperboard within its elastic region; or
a retractable ridged platen, such that the ridge is shaped to maintain the deflection of the paperboard within its elastic region.

8. The apparatus of claim 6 or 7 further including a means for scaling the mapped data logarithmically depending upon the speed of the moving web.

9. The apparatus according to any one of claims 6 to 8 further including a means for scaling the mapped data depending upon the grammage of the paperboard product.

10. In an in-line process for manufacturing paperboard, a method of determining a strength characteristic of the paperboard product, the method including the steps of:
applying a deflection force to a moving web of the paperboard product;
selectively adjusting the deflection force in order to maintain the deflection of the paperboard product with an elastic deflection region; and
measuring the applied force and corresponding displacement of the paperboard product.

11. A method as claimed in claim 10, further including the step of mapping the applied force data against the displacement data.

12. The method of claim 10 or 11, further including the step of applying a logarithmic correction to mapped data, the value of the logarithmic correction dependent upon the speed of the moving paperboard product during measurement.

13. The method of claim 10, 11 or 12, further including the step of scaling the mapped data depending upon the grammage of the paperboard product.

14. A method of monitoring paperboard being manufactured by a paperboard manufacturing apparatus, the method including the step of:
testing the shear strength of manufactured paperboard by application of an MD shear testing method directly to the paperboard wherein the MD shear testing method maintains deflection of the paperboard within an elastic deflection region.

15. A method according to claim 14, wherein the paperboard product is corrugated paperboard, and the test is conducted on the paperboard in a region of 3 to 10 flutes in length.

16. A device adapted to implement the method as claimed in any one of claims 14 or 15.

17. A device for monitoring paperboard being manufactured by a paperboard manufacturing apparatus, the device including:
means for applying an MD shear testing method directly to the paperboard being manufactured and;
means for maintaining the application of the MD shear test within an elastic deflection region.

18. A device as claimed in claim 17, wherein the means for applying an MD shear test is a three point compression apparatus.

19. A device as claimed in any one of claims 17 or 18, further including means for providing an indication that the MD shear is within or outside the elastic deflection region.

20. A method according to either claim 4, 10 or 14 substantially as herein before described with reference to the accompanying diagrams.

21. An apparatus or device according to any one of claims, 1, 6, 16 or 17 substantially as herein before described with reference to the accompanying diagrams.
